(19) United States
(12) Patent Application Publication
(10) Pub. No.: US 2006/0290266 A1
(43) Pub. Date: Dec. 28, 2006

(54) Flat panel backlight unit

(75) Inventors: Nam-Kwon Cho, Taipei City (TW); Jae-Hong Lee, Taipei City (TW)

Correspondence Address: MathBright Technology Co., Ltd., P.O. Box No. 6-57, Junghe, Taipei, 235, TW

(73) Assignee: MathBright Technology Co., Ltd., Taoyuan (TW)

(21) Appl. No.: 11/165,058

(22) Filed: Jun. 24, 2005

(51) Int. Cl. H01J 63/04

(52) U.S. Cl. 313/496; 362/613

(57) ABSTRACT

A flat panel backlight unit having primary application in providing the backlight requirements of LCD monitors, and structured from flat glass panels including a top panel and a bottom panel joined together. An internal surface of the bottom panel is covered with a layer of protective film and fluorescent agent, and an inert gas is filled between the top and bottom panels. The fluorescent agent releases light after undergoing electric discharge, which forms the oriented light source that provides a backlight source for the LCD monitor.

### BACKGROUND OF THE INVENTION

(a) Field of the Invention

The present invention relates to a flat panel backlight unit having primary application in providing the backlight requirements of LCD (liquid crystal display) monitors, and more particularly to a backlight unit structured from flat glass panels that is used to provide an oriented light source.

(b) Description of the Prior Art

Surface treated transparent glass panels with liquid crystals injected there between are used to enable lettering or images to appear on the conventional LCD (liquid crystal display) monitor, wherein a drive circuit of an LCD (liquid crystal display) controller produces a drive signal that imparts appropriate different voltage values in accordance with the distribution of the liquid crystals to enable the liquid crystals to undergo a phase change, with the result that the designated lettering or images appear on the LCD (liquid crystal display) monitor. However, because the panel of the LCD (liquid crystal display) monitor that displays the lettering or images is unable to singly generate a light source, thus, there is the need for a light source to support the appearance of lettering or images, and such a light source is a backlight unit (BLU). The conventional backlight unit is categorized according to the position of the light source and projection direction of light produced, and can be divided roughly into two types, that is, edge type and direct type. Referring to FIG. 1, which shows an edge type backlight unit 10, wherein light sources 101 are respectively installed in side portions of a panel. Light projected into the panel from the side light sources 101 is guided towards an obverse side (that is, a rear face of the panel) through the aid of a light guide panel 103, and after reflecting panels (102 and 104) have reflected the light, a light emitting portion 105 forms an oriented backlight source, which illuminates the display panel. Referring to FIG. 2, which shows a traditional direct type backlight unit 20, structured from a plurality of cold cathode fluorescent lamps (CCFL) 201 distributed in a rear portion of a panel, which are used as light sources and directly oriented towards the panel to provide the required light source. The traditional direct-type backlight unit 20 further uses a reflecting panel 202 to reflect and diffuse the light produced by the cold cathode fluorescent lamps (CCFL), which then illuminates the LCD (liquid crystal display) panel.

Overall, the two aforementioned conventional backlight units 10, 20 have the following respective shortcomings when in use, where improvement is still needed. Brightness of the edge type backlight unit 10 is relatively low because it does not use a direct light method to provide the required light source. Moreover, manufacturing cost is relatively high. Furthermore, because the edge type backlight unit 10 needs the additional installation of the light guide panel (LGP) 103 to deflect the light rays, thus, weight of the edge type backlight unit 10 is relatively heavy, and cost of the light guide panel (LGP) 103 is also relatively high. Because the direct type backlight unit 20 uses a distribution of a plurality of cold cathode fluorescent light tubes 201 as a light source, thus, inaccuracy in spacing between each and position of the light tubes 201 easily results in the light source producing an uneven light. Moreover, the direct type backlight unit 20 is relatively thick because of the need for the additional installation of the light tubes 201, which evidently increases space required to install the direct type backlight unit 20. In addition, the cold-cathode tubes 201 are expensive, and are a cause for environmental concern. Furthermore, according to recent application of plasma panels in display panel art, although the plasma panel has eliminated the need for mercury, a substance that causes environment pollution, however, it has low efficiency, and manufacturing cost is extremely high. Hence, it is still early for practical application of plasma panels in backlight units.

### SUMMARY OF THE INVENTION

In light of the aforementioned problems, a primary objective of the present invention is to provide a flat panel backlight unit that furnishes an oriented light source, is thin, easy to manufacture and of low cost to better accord with use requirements of an LCD (liquid crystal display) monitor.

Another objective of the present invention is to provide an improved flat backlight unit having an improved uniformity of light source and brightness of greater consistency. The flat panel backlight unit of the present invention is primarily structured from flat glass panels including a top panel and a bottom panel joined together. An internal surface of the bottom panel is covered with a layer of protective film and fluorescent agent, and an inert gas is filled between the top and bottom panels. The fluorescent agent releases light after undergoing electric discharge, which forms the oriented light source that provides a backlight source for the LCD (liquid crystal display) monitor.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a side view of a conventional edge type backlight unit.

FIG. 2 shows a side view of a conventional direct type backlight unit.

FIG. 3 shows a side view according to the present invention.

FIG. 3A shows a blowup view of part A of FIG. 3.

FIG. 4 shows a top view according to the present invention.

FIG. 4A shows a blowup view of part A of FIG. 4.

FIG. 5 shows a cross-sectional view according to the present invention.

FIG. 6 shows another cross-sectional view according to the present invention (1).

FIG. 7 shows another cross-sectional view according to the present invention (2).

FIG. 8 shows a preferred embodiment according to the present invention.

FIG. 9 shows a side schematic view according to the present invention.

FIG. 10 shows another preferred embodiment according to the present invention (1).

FIG. 11 shows another preferred embodiment according to the present invention (2).

FIG. 12 shows another preferred embodiment according to the present invention (3).

FIG. 13 shows another preferred embodiment according to the present invention (4).

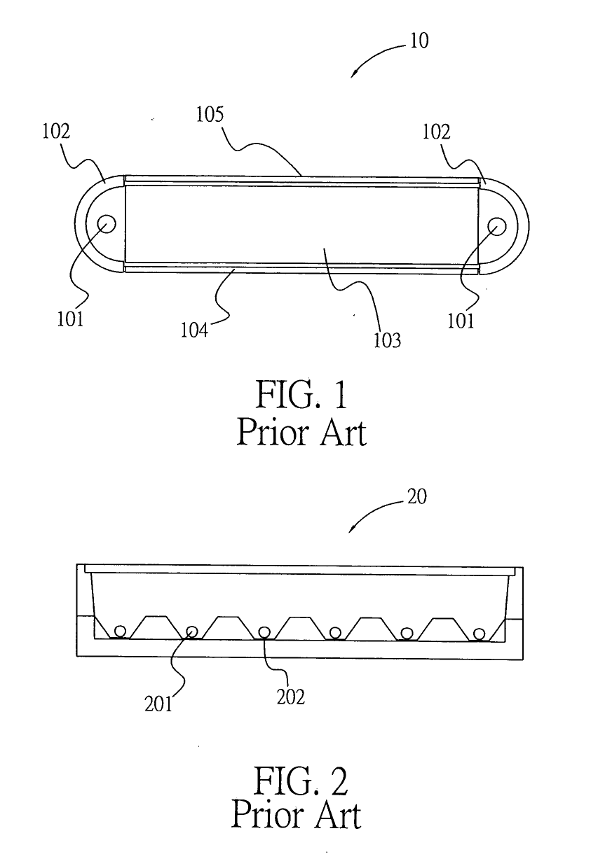

### DETAILED DESCRIPTION OF THE PREFERRED EMBODIMENTS

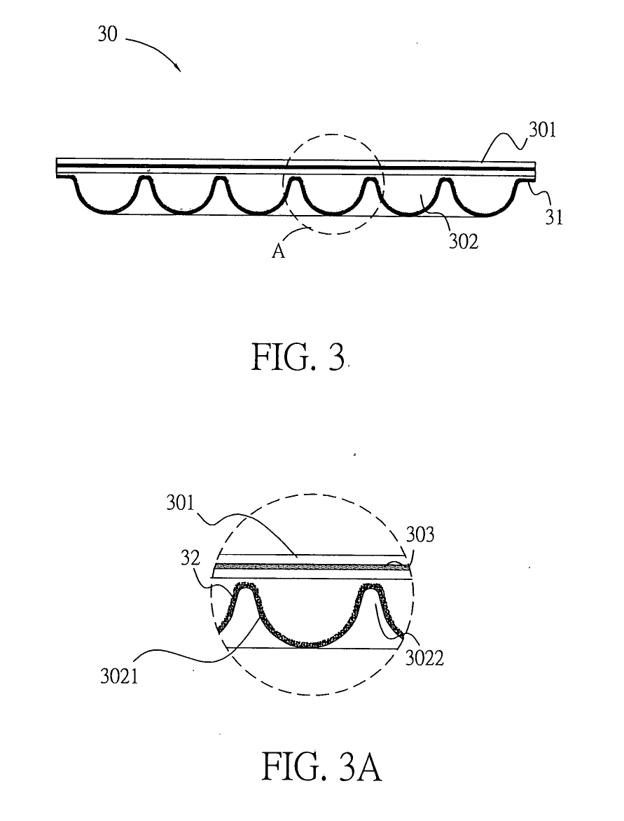

Referring to FIG. 3 and FIG. 3A, which shows a flat panel backlight unit 30 of the present invention, primarily structured to comprise a top panel 301 and a bottom panel 302, wherein the top panel 301 assumes a planar form, and the bottom panel 302 is of corrugated form with a plurality of passageways and a plurality of separated light emitting portions 3021. Wing portions 31 are formed on peripheries of the light emitting portions 3021. A spacing between each of the light emitting portions 3021 forms a discharge passageway 3022. Furthermore, an inner surface of the bottom panel 302 is coated with a protective film and a fluorescent agent 32 (or a mixture of the two). The top panel 301 and the bottom panel 302 are joined together using glass cement 303 having good light guide properties, thereby forming a sealed space between the two, which can be filled with an inert gas.

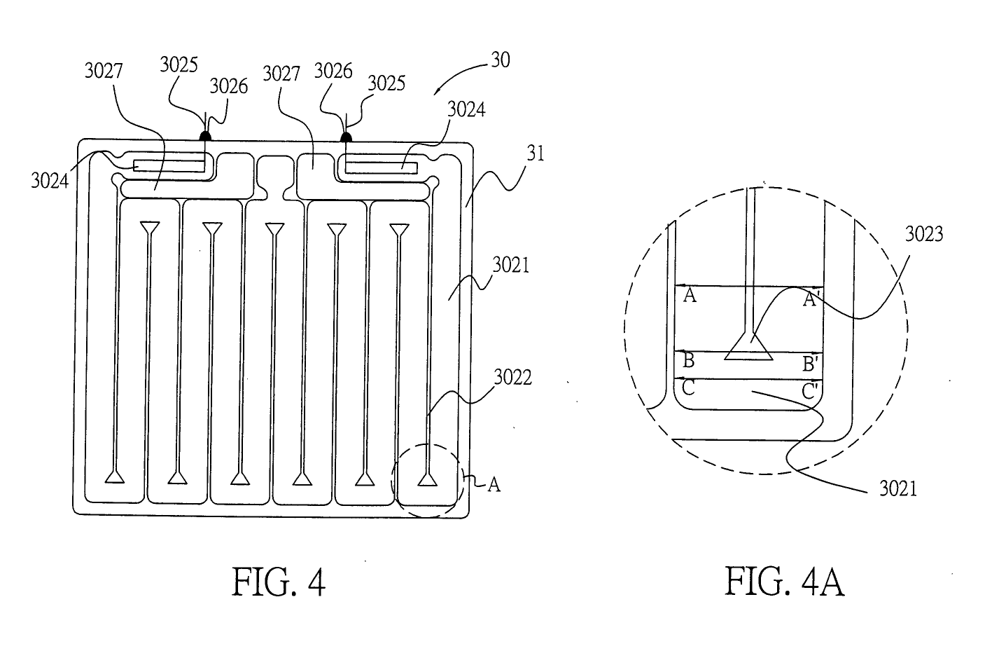

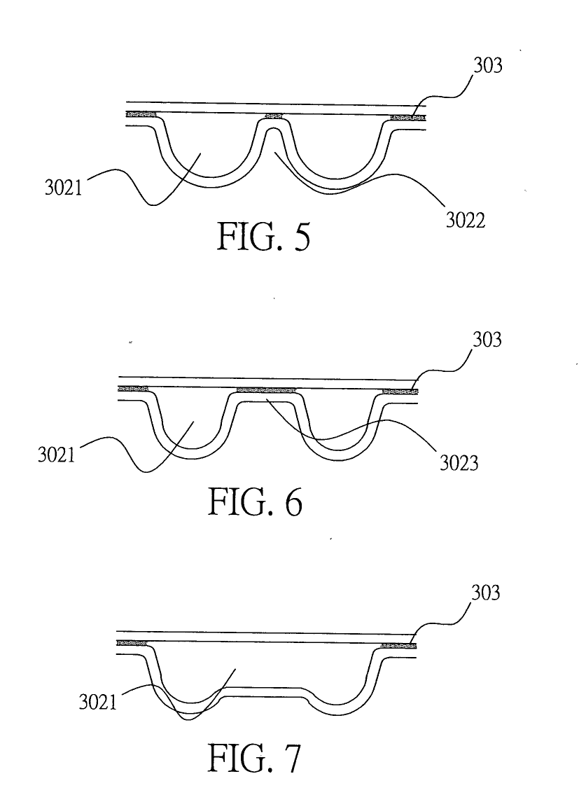

Referring to FIG. 4 and FIG. 4A, which shows a top view of the flat panel backlight unit 30 of the present invention, wherein the bottom panel 302 of the flat panel backlight unit 30 is shaped by heating and molding glass to form the light emitting portions 3021 of corridor form. The discharge passageways 3022 are spaced between each of the light emitting portions 3021, and a triangular deflecting portion 3023 is formed at a linking area between each of the light emitting portions 3021 and the discharge passageways 3022, The primary reason for the deflecting portion 3023 having a triangular shape is because it is easily separated from the mold during the difficult process of heat molding the bottom panel 302 from glass, and thus relatively easy to manufacture, which increases productivity. Furthermore, the deflecting portions 3023 are part of the discharge passageways 3022, accordingly, hence, when discharging, because the triangular deflecting portions 3023 widen the width of the discharge passageways 3022, thus, light passing therethrough forms a light source that assumes a triangular shape when reflected therefrom. Furthermore, referring to FIGS. 5, 6 and 7, which are cross-sectional views along lines A˜A′. B˜B′ and C˜C′ of the enlarged partial view of FIG. 4 and FIG. 4A respectively, wherein respective height positions of the light emitting portions 3021 are slightly lower than those of the deflecting portions 3023, thereby increasing uniformity of luminance, which thus enhances surface brightness of the backlight unit (BLU) 30, moreover, uniformity is high (compared with Y-shaped or T-shaped designs for the deflecting portions 3023). In addition, an electrode 3024 is disposed on an end of each of two sides of the light emitting portions 3021, and a lead-in wire 3025 is configured on each of the electrodes 3024 to connect electricity. Furthermore, in order to prevent the lead-in wires 3025 from breaking, a hot melt method is used to affix each of the lead-in wires 3025 to a connecting area where the line-in wires 3025 join with the flat panel backlight unit 30. Moreover, because the flat panel backlight unit 30 uses the principle of the cold-cathode fluorescent tube, thus, temperature at the position of the electrodes 3024.is higher than that at other positions, accordingly, a cooling hole 3027 is respectively defined on the end of each of the two sides of the light emitting portions 3021.which dissipate heat and thus prevent damage to the backlight unit 30 from overheating when emitting light. Referring to FIG. 8, because the interior of the backlight unit 30 is regulated to have temperature uniformity, thus, uniformity of light is improved, which can prevent color change in certain portions because of yellowing. Furthermore, air outlets 404 are defined at the positions of the electrodes 3024 and surrounding housing portion of the bottom panel 302 (see FIG. 8), which can control the possible rise in temperature when the backlight unit 30 is running for long periods of time. Moreover, when there is need for higher luminance, because of the higher heat generated at the air outlets 404, a forced ventilation method can be used to force air into the backlight unit 30 by means of a fan.

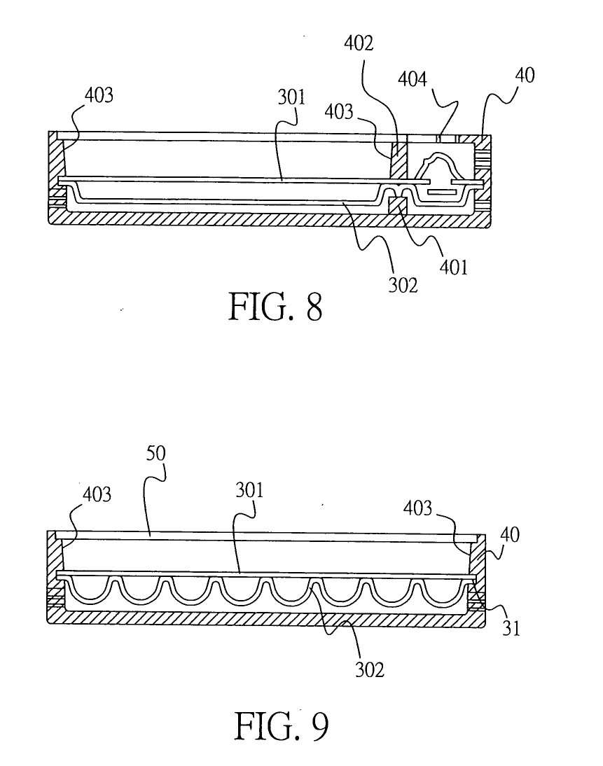

Referring to FIGS. 8 and 9, the flat panel backlight unit 30 of the present invention is further provided with the wing portions 31 of an outer frame 40 for easy securing to the backlight unit (BLU) 30. Hence, the outer frame 40 and a plurality of support frames (401, 402) are all that are required to complete assembly of the backlight unit 30, which is not only simple, but also enables fabricating a highly efficient backlight unit (BLU). A diffuser panel 50 is then disposed on top of the backlight unit (BLU) 30 to complete the simple structure. Furthermore, when manufacturing a large size liquid crystal screen, only the outer frame 40 needs to be enlarged, with inclined planes 403 configured interior of the outer frame 40 and on sides of the support frame 402, thereby enabling the flat panel backlight unit 30 of one size to be assembled with a display screen of different sizes.

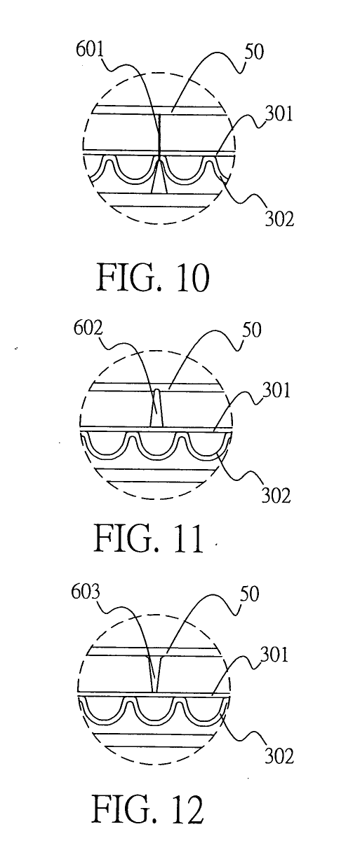

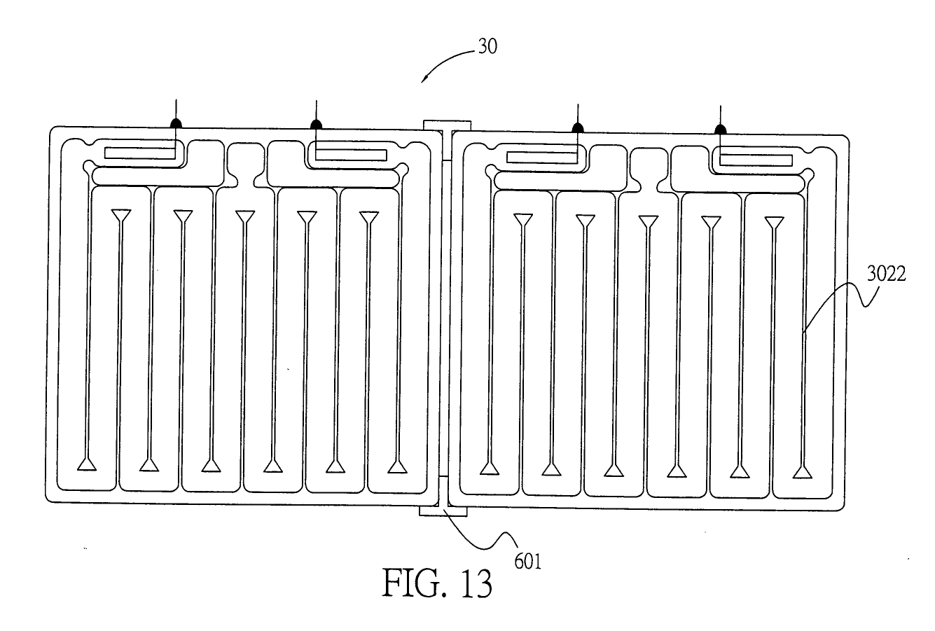

Referring to FIGS. 10, 11 and 12, because temperature of the flat panel backlight unit 30 rises after disposing support posts on the surface of the flat panel backlight unit 30 for fitting the diffuser panel 50 thereon, thus, there is the concern that the support posts will come away after a certain period of time. Hence, in order to resolve such apprehension over the support posts, the present invention inserts a support frame 601 center of the diffuser panel 50. The support frame 601 is made from the same material as that of the diffuser panel 50, thereby eliminating the concern about melting and coming away. However, because there is the problem of the diffuser panel 50 becoming deformed with increased use, and a problem arising in the uniformity of light from the light source, thus, the flat panel backlight unit 30 of the present invention further includes support frames (601, 602, 603) of various forms as depicted in FIGS. 10, 11 and 12 respectively, which serve diverse purposes in different applications, and which can be adjusted to accord with application and size.

Flat panel backlight units are manufactured in sizes ranging from small scale (20×50 mm) to large scale (500×600 mm) or manufactured to meet the requirements of diverse specifications. Hence, when manufacturing a backlight unit of larger size, two or more than two backlight units must be assembled together, thereby saving on manufacturing time and expense. However, under circumstances where two or more than two mutually different backlight units are assembled together, there is concern about damage occurring because of mutual contact between the backlight units. Moreover, loss in quantity of light arises because of machining carried out on edge portions of the backlight units. Referring to FIG. 13, wherein strong heat resistant material such as shock-proof silicon material is used at a center of a top portion and a lower portion of two of the backlight units 30 to join the two together to form a backlight unit of larger size, and a space of less than 1 mm is maintained between the two backlight units 30, thereby enabling even more reflected light to pass through. Even though the space between the backlight units 30 is wider than that of the discharge passageways 3022 interior of the flat fluorescent lamps (FFL), however, uniformity of surface light source luminance is maintained. Furthermore, when assembling two of the backlight units 30, various methods can be employed for the backlight units 30 to come in contact using a thin coating of transparent heat resistant material, such as silicon, which can be used internally, and a large-sized lamp can be used to resolve concern about external impacts when in use.

In conclusion, practical implementation of the present invention has shown that it achieves the objective of providing a flat panel backlight unit that can produce an oriented light source, is simple to manufacture and of low cost, and thus in better accord with use requirements of an LCD (liquid crystal display) panel. Moreover, the present invention provides an improved flat panel backlight unit that achieves the objective of furnishing a light source of greater uniformity and brightness of greater consistency.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A flat panel backlight unit, comprising:
a transparent top panel;
a bottom panel, an airtight space is formed after reciprocal assembly of the top panel and the bottom panel, a plurality of light emitting portions are formed in the bottom panel, each of which are separated by a discharge passageway, and a connection is formed between each of the light emitting portions, an inner surface of each of the light emitting positions is coated with a fluorescent agent; and
a set of electrodes connected to the discharge passageways, light is emitted after electricity is connected to the electrodes, and transparency of the top panel enables formation of an oriented light source.

2. The flat panel backlight unit according to claim 1, wherein the top panel and the bottom panel are joined together using glass cement.

3. The flat panel backlight unit according to claim 1, wherein the connection forms a deflecting portion, which assumes a triangular or circular shape.

4. The flat panel backlight unit according to claim 3, wherein height of the light emitting portions is relatively lower that of the deflecting portions.

5. The flat panel backlight unit according to claim 1, wherein at least one air outlet is defined at an end of the light emitting portions.

6. The flat panel backlight unit according to claim 5, wherein a heat-dissipating fan is disposed external of the air outlet.

7. The flat panel backlight unit according to claim 1, wherein at least one cooling hole is defined at the end of the light emitting portions.

8. The flat panel backlight unit according to claim 1, wherein a plurality of support frames are used to mutually assemble two or more of the flat backlight units.

9. The flat panel backlight unit according to claim 1, wherein the backlight unit can be further assembled with an outer frame and a liquid crystal panel to fabricate a display monitor.

10. The flat panel backlight unit according to claim 9, wherein an interior of the outer frame is provided with inclined planes, angles of which can be adapted according to requirements, thereby enabling changing light emitting angle of the flat panel backlight unit.

11. A flat panel backlight unit, comprising:
a transparent top panel;
a bottom panel, an airtight space is formed after reciprocal assembly of the top panel and the bottom panel, a plurality of light emitting portions are formed in the bottom panel, each of which are separated by a discharge passageway, and a connection is formed between each of the light emitting portions, an inner surface of each of the light emitting positions is coated with a fluorescent agent;
a set of electrodes connected to the discharge passageways, light is emitted after electricity is connected to the electrodes, and transparency of the top panel enables formation of an oriented light source; and
a diffuser panel, which scatters the light source transmitted through the top panel.

12. The flat panel backlight unit according to claim 11, wherein at least one support frame is disposed between the diffuser panel and the top panel.

13. The flat panel backlight unit according to claim 11, wherein the top panel and the bottom panel are joined together using glass cement.

14. The flat panel backlight unit according to claim 11, wherein the connection forms a deflecting portion, which assumes a triangular or circular shape.

15. The flat panel backlight unit according to claim 14, wherein height of the light emitting portions is relatively lower that of the deflecting portions.

16. The flat panel backlight unit according to claim 11, wherein at least one air outlet is defined at an end of the light emitting portions.

17. The flat panel backlight unit according to claim 16, wherein a heat-dissipating fan is disposed external of the air outlet.

18. The flat panel backlight unit according to claim 11, wherein at least one cooling hole is defined at the end of the light emitting portions.

19. The flat panel backlight unit according to claim 11, wherein the backlight unit can be further assembled with an outer frame and a liquid crystal panel to fabricate a display monitor.

20. The flat panel backlight unit according to claim 19, wherein an interior of the outer frame is provided with inclined planes, angles of which can be adapted according to requirements, thereby enabling changing light emitting angle of the flat panel backlight unit.
